(19) United States
(12) Patent Application Publication
(10) Pub. No.: US 2021/0094457 A1
(43) Pub. Date: Apr. 1, 2021

(54) Pivotable, Translatable Container Assembly For A Vehicle Bed

(71) Applicant: Mahindra N.A. Tech Center, Auburn Hills, MI (US)

(72) Inventors: John P. PACELLA, Rochester Hills, MI (US); Robert FEHAN, Clarkston, MI (US); Dennis CINCO, St. Clair Township, MI (US)

(21) Appl. No.: 16/583,385

(22) Filed: Sep. 26, 2019

(51) Int. Cl. B60P 1/32; B60P 1/28

(52) U.S. Cl. CPC B60P 1/32; B60P 1/28

(57) ABSTRACT

A pivotable bracket assembly adapted to be coupled to a vehicle bed includes a base, a frame, and a support. The frame has a first fixed end pivotally coupled to the base and a first free end. The frame can pivot about a first transverse axis. The frame can receive a container. The support has a second fixed end pivotally coupled to the base and a second free end. The support can to pivot about a second transverse axis. The second free end can slidingly engage the frame. Pivoting of the support about the second transverse axis causes the second free end to slidingly engage the frame and rotate the frame about the first transverse axis. The assembly is moveable between a stowed position and an angled position by pivoting the support about the second transverse axis.

### FIELD

The present disclosure relates to a pivotable and translatable container assembly for a vehicle bed.

### BACKGROUND

This section provides background information related to the present disclosure which is not necessarily prior art.

Vehicles, such as utility task vehicles (UTVs), may be used to transport objects or materials. Objects or materials may be loaded or unloaded from a vehicle by lifting the object off of a vehicle bed, by way of example. Vehicles may include features to facilitate loading or unloading, such as hinged doors.

### SUMMARY

This section provides a general summary of the disclosure, and is not a comprehensive disclosure of its full scope or all of its features.

The present disclosure provides a pivotable bracket assembly adapted to be coupled to a vehicle bed. The pivotable bracket assembly includes a base, a frame, and a support. The base includes a pair of substantially parallel longitudinally-extending rails. The base is adapted to be coupled to the vehicle bed. The frame has a first fixed end and a first free end. The first fixed end is pivotally coupled to the base. The frame is adapted to pivot about a first transverse axis. The frame is adapted to receive a container. The support has a second fixed end and a second free end. The second fixed end is pivotally coupled to the base. The support is and adapted to pivot about a second transverse axis substantially parallel to the first transverse axis. The second free end is adapted to slidingly engage the frame. Pivoting of the support about the second transverse axis causes the second free end to slidingly engage the frame and rotate the frame about the first transverse axis. The pivotable bracket assembly is moveable between a stowed position and an angled position by pivoting the support about the second transverse axis.

In some configurations, the pivotable bracket assembly comprises a roller. The roller is rotatably coupled to the second free end of the support. The roller travels along a surface of the frame when the pivotable bracket assembly moves between the stowed position and the angled position.

In some configurations, the pivotable bracket assembly further comprises a lock. The lock is adapted to engage at least one of the support or the frame to prevent the pivotable bracket assembly from moving from the stowed position to the angled position.

In some configurations, the pivotable bracket assembly further comprises a lock. The lock is adapted to engage at least one of the support or the frame to retain the pivotable bracket assembly in at least one of the stowed position or the angled position.

In some configurations, the lock includes a pin coupled to the support. The pin is adapted to be received in a first aperture in the frame to retain the pivotable bracket assembly in the angled position. The pin is adapted to be received in a second aperture in the frame to retain the pivotable bracket assembly in the stowed position.

In some configurations, the frame includes a pair of longitudinally-extending bars and a pair of transversely-extending bars. The pair of longitudinally-extending bars extends between the first fixed end and the first free end. The pair of longitudinally-extending bars extends substantially parallel to the pair of rails when the pivotable bracket assembly is in the stowed position. The pair of transversely-extending bars is coupled to the pair of longitudinally-extending bars. The pair of transversely-extending bars extends between the pair of longitudinally-extending bars.

In some configurations, the support includes a transversely-extending shaft, a pair of longitudinally-extending bars, and a transversely-extending bar. The transversely-extending shaft is disposed at the second fixed end. The transversely-extending shaft is pivotally coupled to the base. The pair of longitudinally-extending bars extends between the second fixed end and the second free end. The pair of longitudinally-extending bars is coupled to the transversely-extending shaft. The transversely-extending bar is disposed at the second free end. The transversely-extending bar is coupled to the pair of longitudinally-extending bars. The transversely-extending bar extends between the pair of longitudinally-extending bars.

In some configurations, the support further includes a longitudinally-extending handle. The longitudinally-extending handle is coupled to the transversely-extending shaft. The longitudinally-extending handle is pivotable about the second transverse axis.

In some configurations, the first free end is adapted to be disposed closer to a rear end of the vehicle bed than the first fixed end.

The present disclosures provides a pivotable bracket assembly. The pivotable bracket assembly is adapted to be coupled to a vehicle bed. The assembly comprises a container and a pivotable bracket. The pivotable bracket includes a base, a frame, and a support. The base includes a pair of substantially parallel longitudinally-extending rails. The base is adapted to be coupled to the vehicle bed. The frame has a first fixed end and a first free end. The first fixed end is pivotally coupled to the base. The frame is adapted to pivot about a first transverse axis. The frame is coupled to the container. The support has a second fixed end and a second free end. The second fixed end is pivotally coupled to the base. The support is adapted to pivot about a second transverse axis substantially parallel to the first transverse axis. The second free end is adapted to slidingly engage the frame. Pivoting of the support about the second transverse axis causes the second free end to slide along the frame to rotate the frame about the first transverse axis. The pivotable bracket is moveable between a stowed position and an angled position by pivoting the support about the second transverse axis.

In some configurations, the assembly further comprises a slider. The slider includes a track and a carrier. The track is coupled to the frame. The carrier is slidingly coupled to the track. The container is coupled to the carrier such that the slider is disposed between the frame and the container. The slider is movable between a retracted position and an extended position.

In some configurations, the slider is movable between the retracted position and the extended position independent of a position of the pivotable bracket.

In some configurations, the slider further includes a lock. The lock is adapted to retain the slider in at least one of the extended position and the retracted position.

In some configurations, the container includes a body and a door. The door is pivotally connected to the body.

In some configurations, the door is pivotally connected to the body at two locations.

In some configurations, the pivotable bracket assembly further includes a roller. The roller is rotatably coupled to the second free end of the support. The roller travels along a surface of the frame when the pivotable bracket moves between the stowed position and the angled position.

In some configurations, the frame includes a pair of longitudinally-extending first bars and a transversely-extending second bar. The first bars are disposed substantially parallel to one another and extend between the first fixed end and the first free end. The pair of first bars extends substantially parallel to the pair of rails when the pivotable bracket is in the stowed position. The second bar is coupled to and extending between the pair of first bars. The support includes a transversely-extending shaft, a pair of longitudinally-extending third bars, and a transversely-extending fourth bar. The shaft is disposed at the second fixed end and pivotally coupled to the base. The pair of third bars extend between the second fixed end and the second free end. The pair of third bars is coupled to the shaft. The fourth bar is disposed at the second free end. The fourth bar is coupled to and extending between the pair of third bars.

In some configurations, the first free end is adapted to be disposed closer to a rear end of the vehicle bed than the first fixed end.

The present disclosure pivotable bracket assembly adapted to be coupled to a vehicle bed. The pivotable bracket assembly is adapted to be coupled to a vehicle bed. The assembly comprises a pivotable bracket, a slider, and a container. The pivotable bracket is movable between a stowed position and an angled position. The pivotable bracket comprises a base, a frame, and a support. The base is adapted to be coupled to the vehicle bed. The frame is pivotally coupled to the base and pivotable about a first transverse axis. The support engages the base and the frame. The slider is movable between a retracted position and an extended position. The slider comprises a track and a carrier. The track is coupled to the frame of the pivotable bracket. The carrier is slidingly coupled to the track. The container is coupled to the carrier of the slider.

In some configurations, the support comprises a longitudinally-extending handle. The handle is pivotable about a second transverse axis. Pivoting the handle about the second transverse axis provides torque to move the pivotable bracket from the stowed position to the angled position.

Further areas of applicability will become apparent from the description provided herein. The description and specific examples in this summary are intended for purposes of illustration only and are not intended to limit the scope of the present disclosure.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a partial perspective view of an assembly coupled to a vehicle bed, the assembly including a container, a slider in a retracted position, and a pivotable bracket in a stowed position according to the principles of the present disclosure;

FIG. 2 is a partial perspective view of the assembly and vehicle of FIG. 1 with the slider in an extended position and the pivotable bracket in an angled position;

FIG. 3 is an exploded perspective view of the pivotable bracket of FIG. 1;

FIG. 4 is a top perspective view of the pivotable bracket of FIG. 1 in the stowed position;

FIG. 5 is a bottom perspective view of the pivotable bracket of FIG. 1 in the stowed position;

FIG. 6 is a top perspective view of the pivotable bracket of FIG. 1 in the angled position;

FIG. 7 is a bottom perspective view of the pivotable bracket of FIG. 1 in the angled position;

FIG. 8 is a partial top view of the assembly of FIG. 1 with the slider in the extended position and the pivotable bracket in the stowed position;

FIG. 9 is a sectional view of the slider and pivotable bracket of FIG. 8 taken at line 9-9 of FIG. 8;

FIG. 10 is a side view of the assembly of FIG. 1 with the slider in the extended position and the pivotable bracket in the angled position;

FIG. 11 is an exploded perspective view of the container of FIG. 1;

FIGS. 12A-12E are side views of the assembly of FIG. 1 at different positions during use according to the principles of the present disclosure; FIG. 12A depicts the container in a closed position, the slider in the retracted position, and the pivotable bracket in the stowed position; FIG. 12B depicts the container in the closed position, the slider in the extended position, and the pivotable bracket in the stowed position; FIG. 12C depicts the container in the closed position, the slider in the extended position, and the pivotable bracket in the angled position; FIG. 12D depicts the container in a first open position, the slider in the extended position, and the pivotable bracket in the angled position; and FIG. 12E depicts the container in a second open position, the slider in the extended position, and the pivotable bracket in the angled position; and

FIG. 13 is a perspective view of another pivotable bracket according to the principles of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

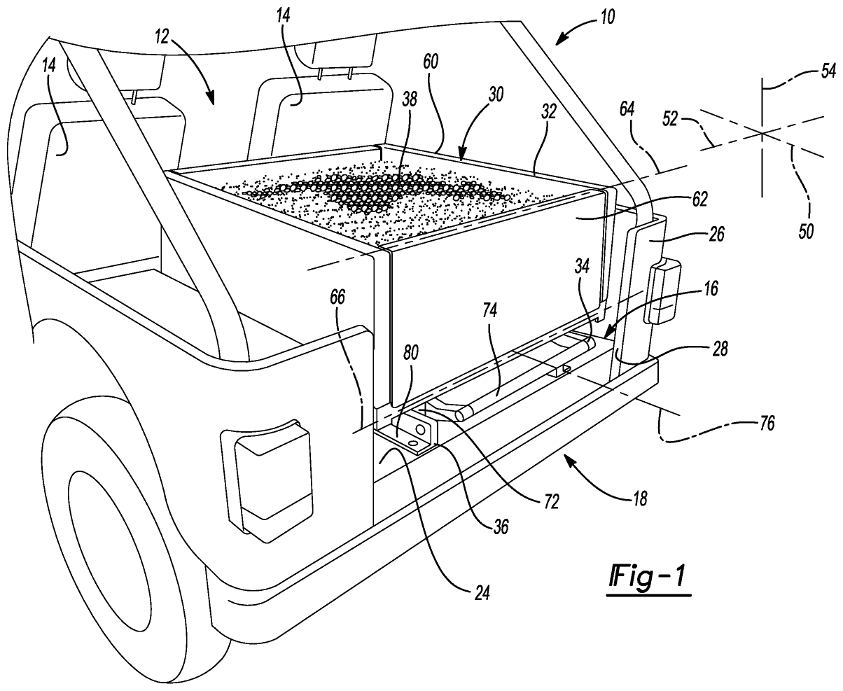

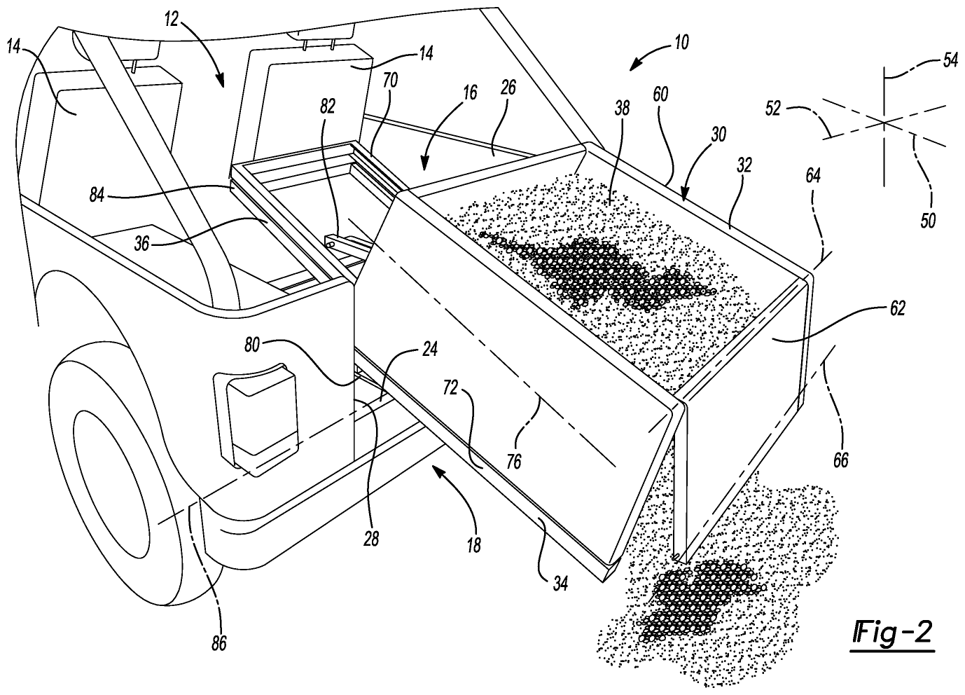

With reference to FIGS. 1-2, a portion of a vehicle 10 according to the principles of the present disclosure is provided. In various aspects, the vehicle may be a 4×4 recreational vehicle with side-by-side seating, such as a UTV. The vehicle 10 may include a passenger cabin 12 including one or more seats 14, such as two seats 14, as shown. The vehicle 10 may include a bed 16 disposed behind the seats 14 adjacent to a rear end 18 of the vehicle 10.

The bed 16 may include a floor 24. The bed 16 may be at least partially surrounded by a wall 26. The wall 26 may include an opening 28 disposed at the rear end 18 of the vehicle 10. The vehicle 10 may further include a pivotable, translatable container assembly 30 coupled to the bed 16.

The assembly 30 may include a container 32, a slider 34, and a pivotable bracket 36. The assembly 30 may be adapted to articulate to selectively position the container 32, such as to perform various tasks. For example, the container 32 may be adapted to store, transport, and/or dispense a granular payload 38. The assembly 30 may be adapted to dispense the payload 38 while stationary and/or while in motion.

The vehicle 10 may generally define an orthogonal coordinate system including a longitudinal axis 50, a transverse axis 52, and a vertical axis 54. The longitudinal axis 50 may generally extend in a fore-and-aft direction with respect to the vehicle 10. The transverse axis 52 may generally extend in a cross-car direction with respect to the vehicle 10.

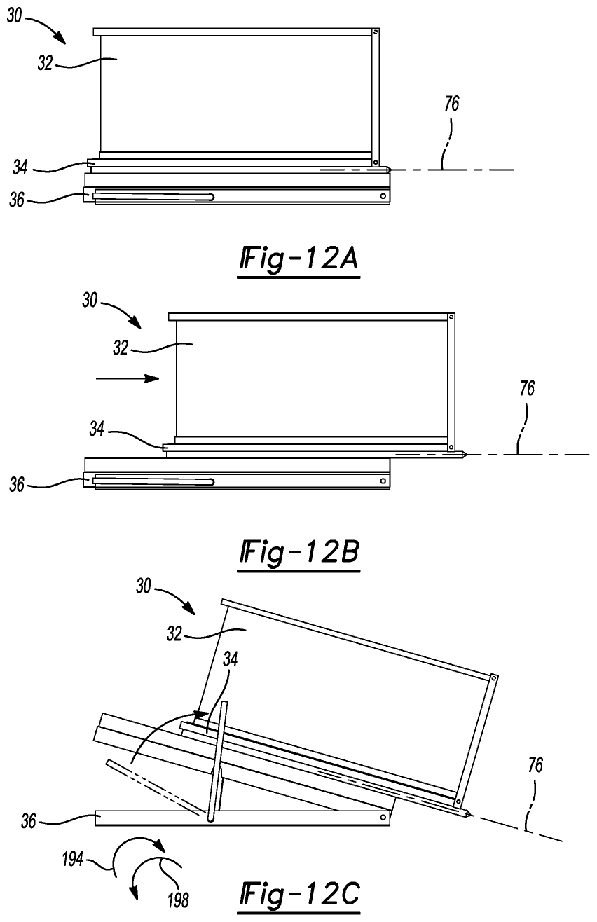

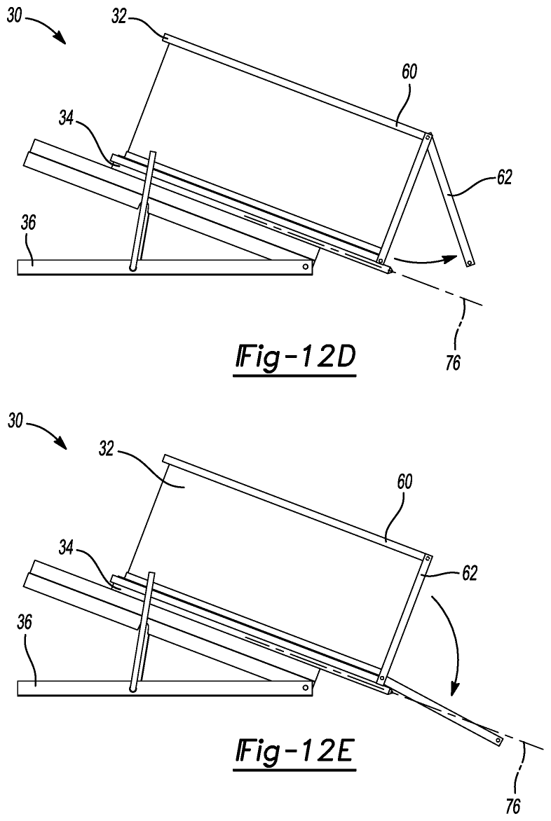

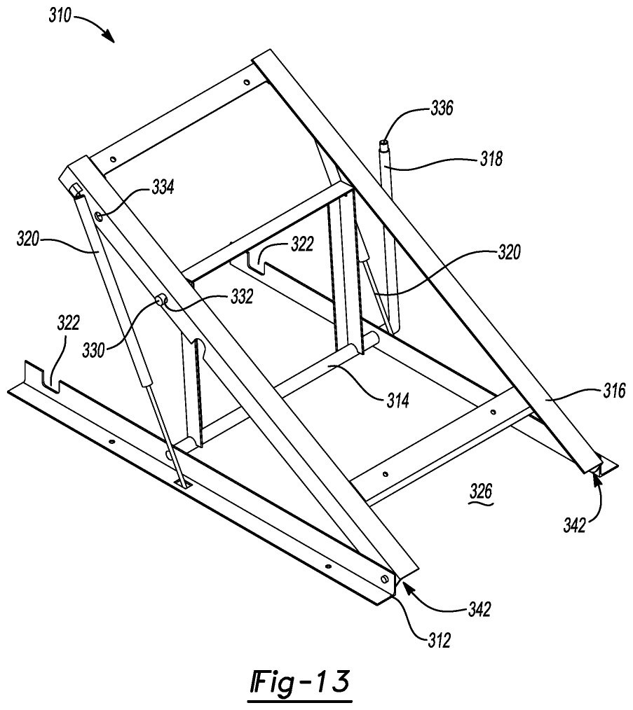

The container 32 may be movable between a closed position (FIGS. 1, 10, 12A-12C), a first open position (FIGS. 2, 12D), a second open position (FIG. 12E), and a third open position (FIG. 11). The slider 34 may be movable between a retracted position (FIGS. 1, 12A) and an extended position (FIGS. 2, 8-10, 12B-12E). The bracket 36 may be movable between a stowed position (FIGS. 1, 4-5, 12A-12B) and an angled position (FIGS. 2, 6-7, 10, 12C-12E). Each of the container 32, the slider 34, and the bracket 36 may be independently movable between its respective positions, including into intermediate configurations and positions not shown. In some examples, the slider 34 is in the retracted position while the bracket 36 is in the angled position.

The positions described above may facilitate loading and/or unloading of objects and materials from the assembly 30. Certain configurations may be useful for unloading a granular material while the vehicle is stationary or in motion. In one example, a granular material may be unloaded at a discrete location by placing the bracket 36 in the angled configuration, the slider 34 in the extended position, and the container 32 in the first open position. In another example, the same configuration may be used to dispense the granular material while the vehicle is moving by engaging one or more locks (FIG. 13) to retain the assembly 30 in the desired configuration. Other uses are also contemplated. For example, the container 32 may be adapted to contain and/or spread a liquid payload. In another example, the assembly 30 may be used without the container 32, such as for facilitating ease of loading and unloading of an object.

Returning to FIGS. 1-2, and as will be described in greater detail below, the container 32 may generally include a body 60 and a door 62. The door 62 may be pivotable with respect to the body 60 about one or more container axes, such as a first container axis 64 and a second container axis 66. In certain aspects, the first and second container axes 64, 66 may extend substantially parallel to the transverse axis 52.

The slider 34 may generally include a track 70 (FIG. 2) and a carrier 72. A position of the track 70 may be fixed with respect to the bracket 36. The carrier 72 may include a handle 74 (FIG. 1). The carrier 72 may be translatable with respect to the bracket 36. For example, the slider 34 may be translatable along a slider axis 76. The slider axis 76 may extend substantially parallel to the longitudinal axis 50 when the bracket 36 is in the stowed position.

As will be described in greater detail below, the bracket 36 may generally include a base 80, a support 82 (FIG. 2), and a frame 84 (FIG. 2). The frame 84 may be adapted to pivot about a primary bracket axis 86. The primary bracket axis 86 may extend substantially parallel to the transverse axis 52.

The bracket 36 may be coupled to the vehicle bed 16. For example, the bracket 36 may be directly coupled to the floor 24. The slider 34 may be coupled to the bracket 36 such that the bracket 36 is disposed between the slide 34 and the floor 24. In certain aspects, the slider 34 may be directly coupled to the bracket 36. The container 32 may be coupled to the slider 34 such that the slider 34 is disposed between the container 32 and the bracket 36. In certain aspects, the container 32 may be directly coupled to the slider 34. In certain alternative aspects, positions of the slider 34 and the bracket 36 may be reversed so that the slider is coupled to the floor 24, the bracket 36 is coupled to the slider 34, and the container 32 is coupled to the bracket 36.

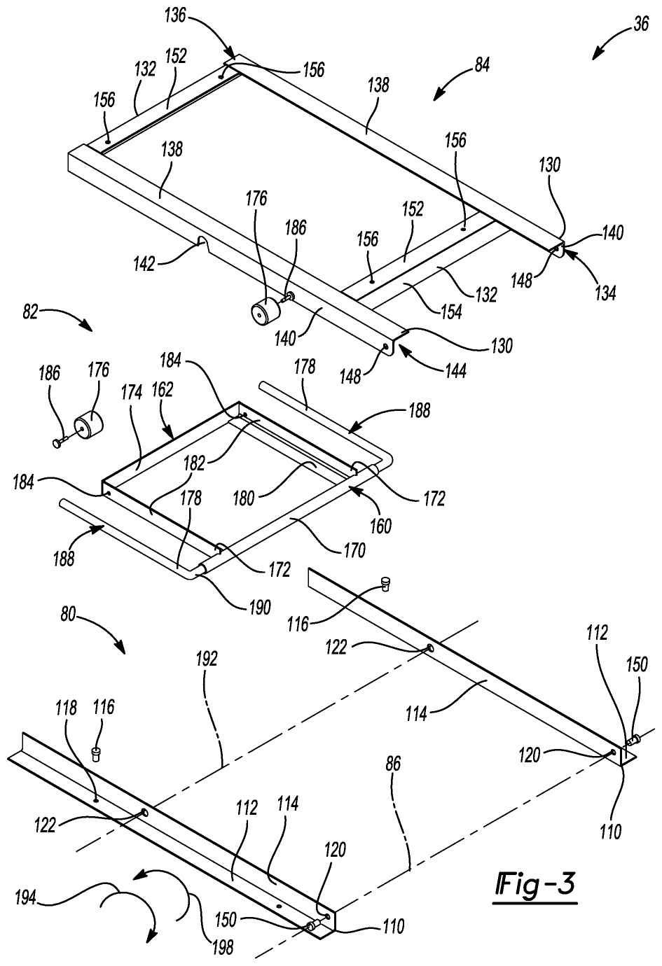

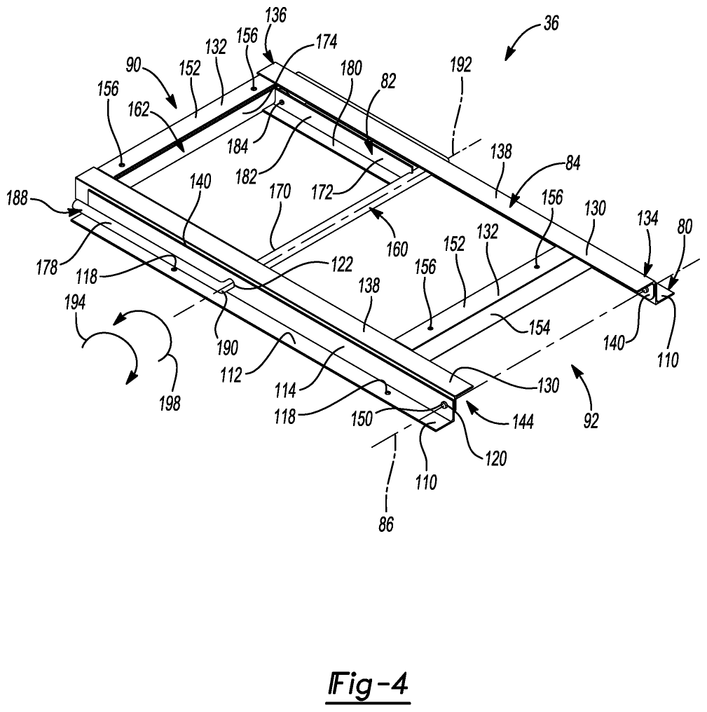

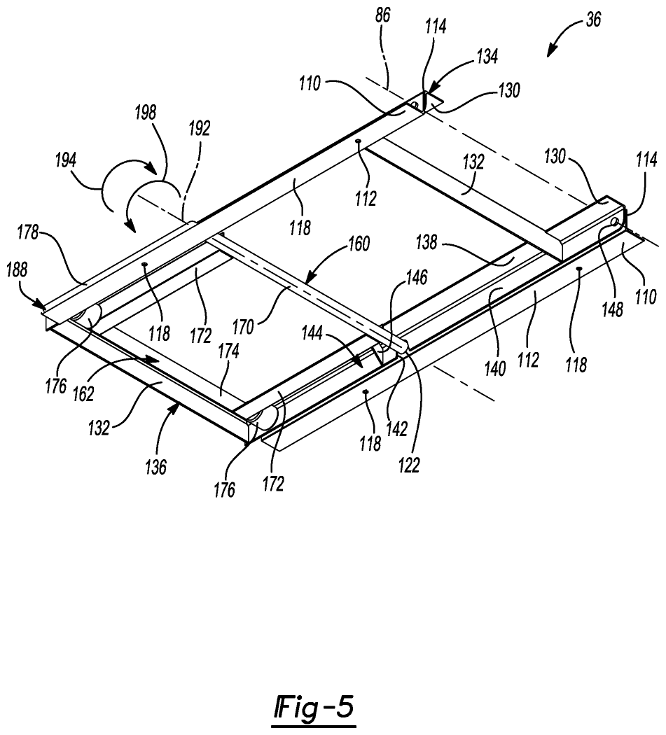

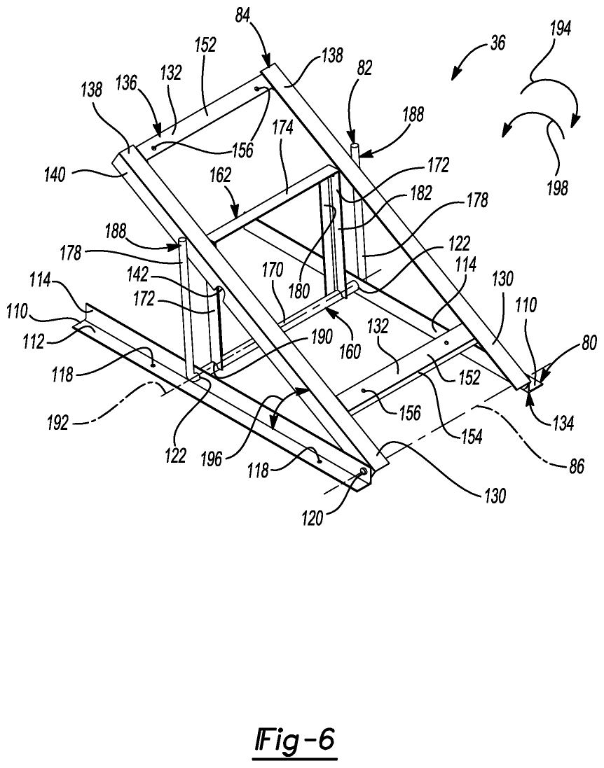

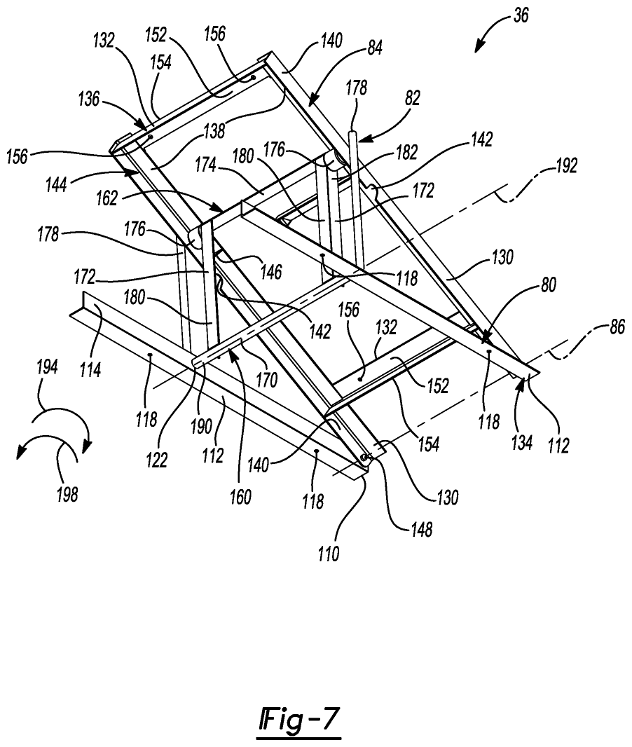

FIGS. 3-7 depict the bracket 36. FIGS. 4-5 show the bracket 36 in the stowed position and FIGS. 6-7 show the bracket 36 in the angled position. As discussed above, the bracket 36 includes the base 80, the support 82, and the frame 84. The bracket 36 may extend longitudinally between a first side 90 and a second side 92. The second side 92 of the bracket 36 may be adapted to be disposed closer to the rear end 18 of the vehicle 10 than the first side 90. Accordingly, the bracket 36 may be adapted to be oriented so that the first side 90 is disposed adjacent to the passenger cabin 12 and the second side 92 is disposed adjacent to the rear end 18 of the vehicle 10.

The base 80 may include a pair of longitudinally-extending bars or rails 110 (i.e., extending substantially parallel to the longitudinal axis 50 of the vehicle 10). The rails 110 may extend substantially parallel to one another between the first side 90 and the second side 92. Each rail 110 may be elongated and have a substantially L-shaped cross section.

Each rail 110 may include a first or horizontal wall 112 and a second or vertical wall 114. The first and second walls 112, 114 may extend substantially perpendicular to one another. The first wall 112 may be adapted to be coupled to the floor 24 of the vehicle bed 16 (FIG. 1). In certain aspects, the first wall 112 of each rail 110 may be directly coupled to the floor 24, such as by a plurality of first fasteners 116 (FIG. 3) that extend through a respective plurality of first apertures 118 formed in the first wall 112.

Each second wall 114 may include a respective second aperture 120 disposed adjacent to the second side 92 of the bracket 36. Each second wall 114 may further include a third aperture 122. The third apertures 122 may be disposed at an intermediate location between the first and second sides 90, 92 of the bracket 36. In certain aspects, the base 80 may include different or additional features, such as one or more transverse bars extending between the rails 110.

The frame 84 may include a pair of longitudinally-extending first bars 130 and one or more transversely-extending second bars 132. The second bars 132 may extend between the first bars 130. The second bars 132 may be coupled to the first bars 130, such as by a plurality of welds. Thus, the bars 130, 132 may cooperate to define a substantially rectangular shape.

The frame 84 may have a first fixed end 134 and a first free end 136. The first fixed end 134 may be disposed adjacent to the second side 92 of the bracket 36. The first free end 136 may be disposed adjacent to the first side 90 of the bracket 36. The first fixed end 134 may be pivotally coupled to the base 80. The first free end 136 may be movable with respect to the base 80.

Each of the first bars 130 may be elongated and have a substantially L-shaped cross section. Accordingly, each first bar 130 may include a third or horizontal wall 138 and a fourth or vertical wall 140. The third and fourth walls 138, 140 may extend substantially parallel to one another. Each of the fourth walls 140 may define a notch 142 into which a portion of the support 82 may be disposed when the bracket 36 is in the stowed position. In certain aspects, the notch 142 may be substantially U-shaped.

The third and fourth walls 138, 140 may cooperate to at least partially define an interior region 144. Each of the first bars 130 may further include a substantially triangular brace 146 (FIG. 7) disposed at an intermediate longitudinal location between the first fixed and free ends 134, 136. Each triangular brace 146 may extend between respective third and fourth walls 138, 140 in the interior region 144.

Each of the third walls 138 may include a respective fourth aperture 148. The fourth apertures 148 may be disposed at the first fixed end 134. The fourth apertures 148 may be aligned with respective second apertures 120 of the base 80. A pair of second fasteners 150 (FIG. 3) may extend through the second and fourth apertures 120, 148 to pivotally couple the frame 84 to the base 80 at the second side 92 of the bracket 36. The primary bracket axis 86 may extend through centers of the second apertures 120, fourth apertures 148, and second fasteners 150.

One of the second bars 132 may be disposed adjacent to the first side 90 of the bracket 36 and the other of the second bars 132 may be disposed at an intermediate location between the first and second sides 90, 92 of the bracket 36. Each of the second bars 132 may include a fifth or horizontal wall 152 and a sixth or vertical wall 154 extending substantially perpendicular to the fifth wall 152. The fifth walls 152 may include a plurality of fifth apertures 156 for coupling the track 70 of the slider 34 to the frame 84 (FIG. 2).

The support 82 may include a second fixed end 160 and a second free end 162. The second fixed end 160 may be pivotally coupled to the base 80. The second free end 162 may be movable with respect to the base 80. The second fixed end 160 may be disposed at an intermediate longitudinal position between the first and second sides 90, 92 of the bracket 36. The second free end 162 may be disposed adjacent to the first side 90 of the bracket 36 when the bracket 36 is in the stowed position.

The support 82 may include a transversely-extending shaft 170, a pair of longitudinally-extending third bars 172, a fourth transversely-extending bar 174, one or more rollers 176, and one or more handles 178. The third transversely-extending bars 172 may each be coupled to the shaft 170, such as by welds. The fourth bar 174 may extend between the third bars 172 and be coupled to the third bars 172, such as by a plurality of welds. The shaft 170, the third bars 172, and the fourth bar 174 may cooperate to define a substantially rectangular shape.

Each of the third bars 172 may be elongated and have an L-shaped cross-section. Accordingly each third bar 172 may include a seventh or horizontal wall 180 and an eighth or vertical wall 182. The eighth walls 182 may each include a sixth aperture 184 adjacent to the second free end 162. The rollers 176 are rotatably coupled to respective third bars 172 via third fasteners 186 (FIG. 3) extending through the rollers 176 and sixth apertures 184. In certain alternative aspects, a support may include a single roller or more than two rollers.

The handles 178 may extend outboard of the shaft 170. At least a portion 188 of each handle 178 extends substantially longitudinally. In certain aspects, the shaft 170 is hollow and includes an interior region that receives another connecting bar 190. The connecting bar 190 may extend between the handles 178 and connect the handles 178 to one another. The shaft 170 may be coupled to the handles 178, via the connecting bar 190, so that the handles 178 and connecting bar 190 are adapted to pivot together with the shaft 170. The shaft 170 and connecting bar 190 may be connected to one another via a plurality of welds, by way of example. In various alternative aspects, a support 82 may include a single handle (FIG. 13).

The shaft 170 may be pivotally coupled to the base 80 at the third apertures 122. The shaft 170 may be directly coupled to the base 80 or indirectly coupled to the base 80, such as via the connecting bar 190. A secondary bracket axis 192 may extend through the shaft 170. The support 82 may therefore be pivotable about the secondary bracket axis 192 with respect to the base 80.

When the bracket 36 is in the stowed position, the first, third, fifth, and seventh walls 112, 138, 152, 180 may extend substantially parallel to one another and the floor 24 of the vehicle bed 16 (FIGS. 1-2). The second, fourth, sixth, and eighth walls 114, 140, 154, 182 may extend substantially parallel to one another and substantially perpendicular to the floor 24. The second wall 114 of the base 80 may be disposed adjacent to and outboard of the fourth wall 140 of the frame 84. The notches 142 of the frame 84 may receive portions of the support 82, such as the shaft 170 or the connecting bar 190. A portion of the frame 84 may be disposed forward of the fourth bar 174 of the support 82 (i.e., toward a front end of the vehicle 10). The rollers 176 of the support 82 may be disposed within the interior region 144 of the frame 84.

A user may move the bracket 36 from the stowed position to the angled position by engaging at least one of the handles 178 to pivot the support 82 in a first rotational direction 194 about the secondary bracket axis 192. Rotation of the handles 178 may provide the necessary torque to move the pivotable bracket from the stowed position to the angled position.

During the pivoting, the support 82 slidingly engages the frame 84. More particularly, the rollers 176 of the support 82 engage the third wall 138 of the frame 84 to pivot the frame 84 about the primary bracket axis 86 in the first rotational direction 194. In certain aspects, the rollers 176 may engage the respective triangular braces 146 to prevent further rotation of the support 82, and correspondingly the frame 84, in the first rotational direction 194. The rollers 176 may engage the respective triangular braces 146 at a maximum bracket angle 196. In certain aspects, the maximum bracket angle 196 may be greater than or equal to about 20° to less than or equal to about 40°, optionally greater than or equal to about 25° to less than or equal to about 35°, or optionally about 30°. The user may return the bracket 36 to the stowed position by engaging the handle 178 to pivot the support 82 a second rotational direction 198 opposite the first rotational direction 194.

Bracket 36 may be adapted to be locked in an intermediate position between the stowed position and the angled position corresponding to the maximum bracket angle. In some examples, the bracket 36 may be locked in any intermediate position. In other examples, the bracket 36 may be adapted to be locked in one or more predetermined intermediate positions.

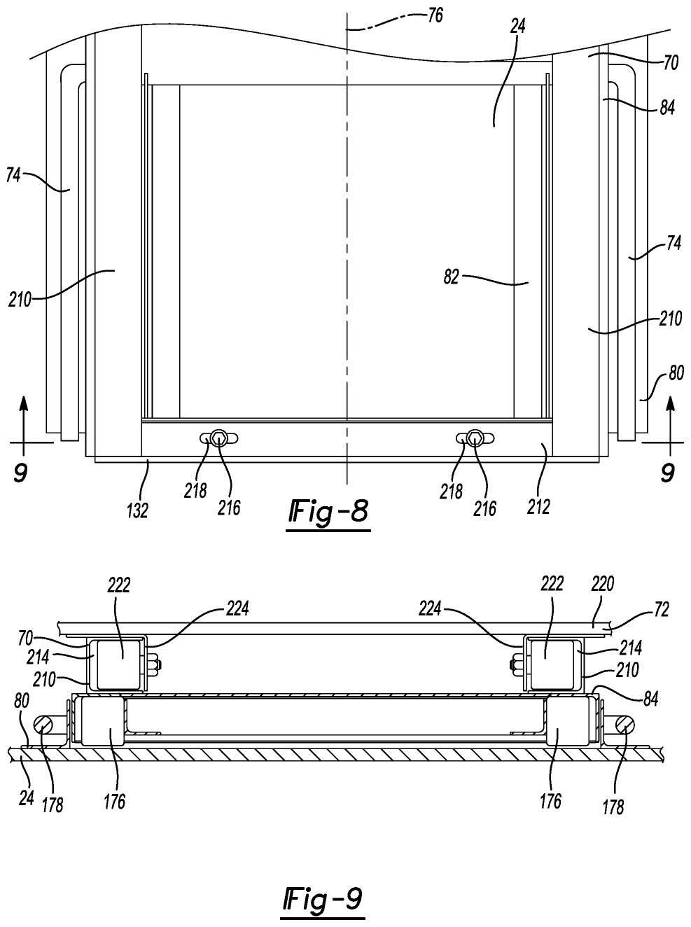

With reference to FIGS. 8-9, the slider 34 includes the track 70 and the carrier 72. The track 70 may include a pair of longitudinally-extending bars 210 and a pair of longitudinally-extending sixth bars 212. The sixth bars 212 may extend between and be coupled to the fifth bars 210. The fifth bars 210 may be elongated and have substantially U-shaped cross sections defining respective interior regions 214. The interior regions 214 of the fifth bars 210 may face inboard toward one another.

The slider 34 is coupled to the bracket 36. More particularly, the sixth bar 212 of the track 70 is coupled to the second bar 132 of the frame 84 of the bracket 36. A plurality of fasteners 216 may extend through a respective plurality of apertures 218 in the sixth bar 212 to engage the second bar 132. The track 70 may be coupled to the frame 84 at one or more additional locations.

The carrier 72 includes a platform 220 and a plurality of rollers 222. The platform 220 may include the handle 74 (FIG. 1). The rollers 222 may be rotatably coupled to the platform 220 via respective corner brackets 224. The rollers 222 may be disposed within the interior region 214 of the track 70.

As noted above, the slider 34 may be adapted to translate between a retracted position (FIG. 1) and an extended position (FIGS. 2, 9). More particularly, the carrier 72 may slidingly engage the track 70 to translate along the slider axis 76 between the retracted and extended positions. The carrier 72 may slidingly engage the track 70 via engagement of the rollers 222 with the fifth bars 210 of the track 70. In certain aspects, the user may engage the handle 74 to push or pull the carrier 72 along the slider axis 76 between the retracted and extended positions. In certain aspects, the slider 34 may further include one or more slider locks (not shown) to retain the slider 34 in the retracted position and/or the extended position.

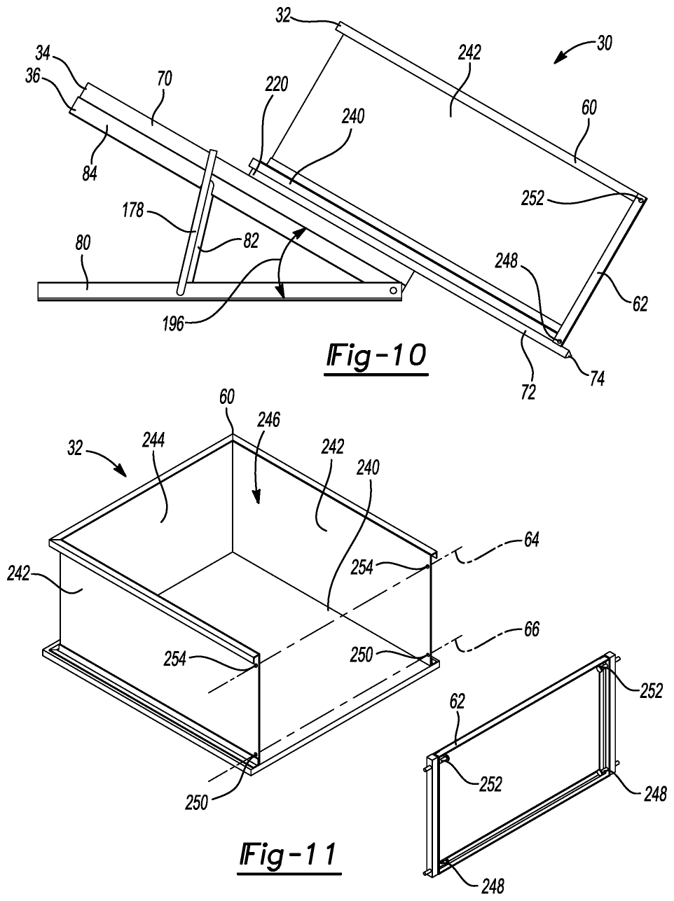

Referring to FIGS. 10-11, the assembly 30 including the container 32, the slider 34, and the bracket 36 is provided. The container 32 may be a dump box having a dual-pivot tailgate. The container 32 includes the body 60 and the door 62. The body 60 may include a bottom wall 240, a pair of opposing first side walls 242, and a second side wall 244. The container 32 may be coupled to the slider 34. More particularly, the bottom wall 240 of the container 32 may be coupled to the platform 220 of the carrier 72 of the slider 34.

The first side walls 242 may extend substantially parallel to one another and substantially perpendicular to the bottom wall 240. The second side wall 244 may extend substantially perpendicular to the bottom wall 240 and the first side walls 242. In certain aspects, the body 60 may have a top opening 246. However, in other aspects, a body may further include a top wall so that it is adapted to be fully enclosed.

The door 62 may be coupled to the body 60. More particularly, the door 62 may be pivotally coupled to one or both of the first side walls 242. In certain aspects, the door 62 may be coupled to the first side walls 242 at two locations so that it can be opened by pivoting about the first container axis 64 or the second container axis 66. The container 32 may include a first pair of pins 248 releasably engaging a first pair of hinge apertures 250, respectively. The container 32 may further include a second pair of pins 252 releasably engaging a second pair of hinge apertures 254, respectively. In certain aspects, the pins 248, 252 may be operatively connected to springs to maintain the pins 248, 252 in respective hinge apertures 250, 254.

The user may remove the first pins 248 from the first hinge apertures 250, such as by squeezing the first pins 248 inboard toward one another, to allow the door 62 to pivot about the first container axis 64 with respect to the body 60 to place the container in the first open position. The user may remove the second pins 252 from the second hinge apertures 254, such as by squeezing the second pins 252 inboard toward one another, to allow the door 62 to pivot about the second container axis 66 with respect to the body 60 to place the container in the second open position. The user may remove the first pins 248 from the first hinge apertures 250 and the second pins 252 from the second hinge apertures 254 to remove the door 62 from the body 60 and place the container 32 in the third open position, as shown in FIG. 11. The container 32 may therefore be adapted to be moved between the closed position, the first open position, the second open position, and the third open position.

An alternate container may include different or additional hinge features to facilitate different opening positions, such as a hinge that facilitates pivotal movement of the door about an axis parallel to the vertical axis 54 (FIGS. 1-2). In still other aspects, a container may be free of a door. For example, the container may be adapted to contain a liquid and include a liquid dispensing component.

Referring to FIGS. 12A-12E, use of the assembly 30 according to the principles of the present disclosure is depicted. FIG. 12A depicts the bracket 36 in the stowed position, the slider 34 in the retracted position, and the container 32 in the closed position. FIG. 12B depicts the bracket 36 in the stowed position, the slider 34 in the extended position, and the container 32 in the closed position. FIG. 12C depicts the bracket 36 in the angled position, the slider 34 in the extended position, and the container 32 in the closed position. FIG. 12D depicts the bracket 36 in the angled position, the slider 34 in the extended position, and the container 32 in the first open position. FIG. 12E depicts the bracket 36 in the angled position, the slider 34 in the extended position, and the container 32 in the second open position. As noted above, each of the container 32, the slider 34, and the container 32 may be adapted to move between its respective positions independent of the others of the container 32, the slider 34, and the bracket 36.

With reference to FIG. 13, another pivotable bracket 310 according to the principles of the present disclosure is provided. The bracket 310 may generally include a base 312, a support 314, and a frame 316. Except as otherwise described, the bracket 310 may be similar to the bracket 36 of FIGS. 3-7. In certain aspects, the support 314 may include a single handle 318.

The bracket 310 may include a pair of gas struts 320 to dampen pivotal speed of the frame 316 with respect to the base 312 when the bracket 310 is moved from an angled position to a stowed position. The gas struts 320 may be operatively coupled the base 312 and at least one of the frame 316 and the support 314. In one example, as shown, the gas struts 320 are pivotally connected to the base 312 and the frame 316. The base 312 may define a notch 322 to provide clearance for the gas struts 320 when the bracket 310 is in the stowed position. The handle 318 may be spaced apart from the base 312 to provide clearance for the gas struts 320.

The bracket 310 may further include one or more locks for retaining the bracket 310 in the stowed position and/or the angled position. In certain aspects, a lock is adapted to both retain the bracket in the stowed position and to retain the bracket in the angled position. The lock may include a pin 332 disposed on the support 314, a first aperture disposed on the frame 316, and a second aperture 334 disposed on the frame 316. The pin 330 may be received in the first aperture 332 to retain the pivotable bracket 310 in the angled position. The pin 330 may be received in the second aperture 334 to retain the pivotable bracket 310 in the stowed position. When the pin 330 engages the frame 306, such as by contact with a surface defining either the first aperture 332 or a surface defining the second aperture 334, the frame 316 is substantially prevented from rotating with respect to the base 312.

In certain aspects, the lock may further include a button 336. The button 336 may be disposed on the handle 318 of the support 314. Pressing the button 336 may release or retract the pin 330 to remove it from the first or second aperture 332, 334 and permit rotation of the frame 316 with respect to the base 312. In certain alternative aspects, a pivotable bracket may include a first lock adapted to retain the pivotable bracket in the angled position and a distinct second lock adapted to retain the pivotable bracket in the stowed position.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A pivotable bracket assembly adapted to be coupled to a vehicle bed, the pivotable bracket assembly comprising:
a base including a pair of substantially parallel longitudinally-extending rails, the base being adapted to be coupled to the vehicle bed;
a frame having a first fixed end and a first free end, the first fixed end of the frame being pivotally coupled to the base and adapted to pivot about a first transverse axis, the frame being adapted to receive a container;
a support having a second fixed end and a second free end, the second fixed end of the support being pivotally coupled to the base and adapted to pivot about a second transverse axis substantially parallel to the first transverse axis, the second free end being adapted to slidingly engage the frame, wherein
pivoting of the support about the second transverse axis causes the second free end to slidingly engage the frame and rotate the frame about the first transverse axis; and
the pivotable bracket assembly being moveable between a stowed position and an angled position by pivoting the support about the second transverse axis.

2. The pivotable bracket assembly of claim 1, further comprising a roller rotatably coupled to the second free end of the support, wherein the roller travels along a surface of the frame when the pivotable bracket assembly moves between the stowed position and the angled position.

3. The pivotable bracket assembly of claim 1, further comprising a lock adapted to engage at least one of the support or the frame retain the pivotable bracket assembly in at least one of the stowed position or the angled position.

4. The pivotable bracket assembly of claim 3, wherein:
the lock comprises a pin coupled to the support;
the pin is adapted to be received in a first aperture in the frame to retain the pivotable bracket assembly in the angled position; and
the pin is adapted to be received in a second aperture in the frame to retain the pivotable bracket assembly in the stowed position.

5. The pivotable bracket assembly of claim 1, further comprising a pair of gas struts operatively connected to the base and one of the frame or the support.

6. The pivotable bracket assembly of claim 1, wherein:
the frame includes a pair of longitudinally-extending bars and a pair of transversely-extending bars;
the pair of longitudinally-extending bars extends between the first fixed end and the first free end, the pair of longitudinally-extending bars extending substantially parallel to the pair of rails when the pivotable bracket assembly is in the stowed position; and
the pair of transversely-extending bars is coupled to and extending between the pair of longitudinally-extending bars.

7. The pivotable bracket assembly of claim 1, wherein:
the support includes a transversely-extending shaft, a pair of longitudinally-extending bars, and a transversely-extending bar;
the transversely-extending shaft is disposed at the second fixed end and pivotally coupled to the base;
the pair of longitudinally-extending bars extends between the second fixed end and the second free end, the pair of longitudinally-extending bars being coupled to the transversely-extending shaft; and
the transversely-extending bar is disposed at the second free end, the transversely-extending bar being coupled to and extending between the pair of longitudinally-extending bars.

8. The pivotable bracket assembly of claim 7, wherein the support further includes a longitudinally-extending handle coupled to the transversely-extending shaft and pivotable about the second transverse axis.

9. The pivotable bracket assembly of claim 1, wherein the first free end is adapted to be disposed closer to a rear end of the vehicle bed than the first fixed end.

10. A pivotable bracket assembly adapted to be coupled to a vehicle bed, the pivotable bracket assembly comprising:
a container; and
a pivotable bracket comprising:
a base including a pair of substantially parallel longitudinally-extending rails, the base being adapted to be coupled to the vehicle bed;
a frame having a first fixed end and a first free end, the first fixed end of the frame being pivotally coupled to the base and adapted to pivot about a first transverse axis, the frame being coupled to the container;
a support having a second fixed end and a second free end, the second fixed end of the support being pivotally coupled to the base and adapted to pivot about a second transverse axis substantially parallel to the first transverse axis, the second free end being adapted to slidingly engage the frame, wherein
pivoting of the support about the second transverse axis causes the second free end to slide along the frame to rotate the frame about the first transverse axis; and
the pivotable bracket being moveable between a stowed position and an angled position by pivoting the support about the second transverse axis.

11. The pivotable bracket assembly of claim 10, further comprising a slider including a track and a carrier, the track being coupled to the frame and the carrier being slidingly coupled to the track, the container being coupled to the carrier such that the slider is disposed between the frame and the container, wherein the slider is movable between a retracted position and an extended position.

12. The pivotable bracket assembly of claim 11, wherein the slider is movable between the retracted position and the extended position independent of a position of the pivotable bracket.

13. The pivotable bracket assembly of claim 11, wherein the slider further includes a lock adapted to retain the slider in at least one of the extended position and the retracted position.

14. The pivotable bracket assembly of claim 10, wherein the container includes a body and a door, the door being pivotally connected to the body.

15. The pivotable bracket assembly of claim 14, wherein the door is pivotally connected to the body at two locations.

16. The pivotable bracket assembly of claim 10, wherein:
the pivotable bracket further includes a roller rotatably coupled to the second free end of the support; and
the roller travels along a surface of the frame when the pivotable bracket moves between the stowed position and the angled position.

17. The pivotable bracket assembly of claim 10, wherein:
the frame includes a pair of longitudinally-extending first bars and a transversely-extending second bar;
the pair of first bars being disposed substantially parallel to one another and extending between the first fixed end and the first free end, the pair of first bars extending substantially parallel to the pair of rails when the pivotable bracket is in the stowed position;
the second bar is coupled to and extending between the pair of first bars;
the support includes a transversely-extending shaft, a pair of longitudinally-extending third bars, and a transversely-extending fourth bar;
the shaft is disposed at the second fixed end and pivotally coupled to the base;
the pair of third bars extend between the second fixed end and the second free end, the pair of third bars being coupled to the shaft; and
the fourth bar being disposed at the second free end, the fourth bar being coupled to and extending between the pair of third bars.

18. The pivotable bracket assembly of claim 10, wherein the first free end is adapted to be disposed closer to a rear end of the vehicle bed than the first fixed end.

19. A pivotable bracket assembly adapted to be coupled to a vehicle bed, the pivotable bracket assembly comprising:
a pivotable bracket movable between a stowed position and an angled position, the pivotable bracket comprising:
a base adapted to be coupled to the vehicle bed;
a frame pivotally coupled to the base and pivotable about a first transverse axis; and
a support engaging the base and the frame;
a slider movable between a retracted position and an extended position, the slider comprising:
a track coupled to the frame of the pivotable bracket; and
a carrier slidingly coupled to the track; and
a container coupled to the carrier of the slider.

20. The pivotable bracket assembly of claim 19, wherein:
the support comprises a longitudinally-extending handle pivotable about a second transverse axis; and
pivoting the handle about the second transverse axis provides torque to move the pivotable bracket from the stowed position to the angled position.
